(19) United States
(12) Patent Application Publication
(10) Pub. No.: US 2013/0212009 A1
(43) Pub. Date: Aug. 15, 2013

(54) System and Method for Assisting Vendors

(71) Applicant: Vendor Assistance Program, LLC, (US)

(72) Inventors: Brian Francis Hynes, Chicago, IL (US); Jeffrey James Balvanz, Denver, CO (US); Aaron A. Hodges, San Francisco, CA (US)

(21) Appl. No.: 13/841,034

(22) Filed: Mar. 15, 2013

Related U.S. Application Data
(63) Continuation of application No. 13/224,274, filed on Sep. 1, 2011.

(51) Int. Cl. G06Q 20/30

(52) U.S. Cl. CPC G06Q 20/30
USPC 705/39

(57) ABSTRACT

A service system for facilitating payment to a vendor of products over a network. The products are supplied to a buyer. The system includes an invoice having a base invoice amount with an amount of penalty funds calculated from the base invoice amount when the invoice is not paid in a timely manner. An application is submitted to an investor via the network for enrolling the vendor in the service system. At least one installment is disbursed from the buyer and received by the investor over the network. At least one payment is disbursed from the investor and received by the vendor over the network wherein the payment is equal to the base invoice amount thereby allowing the vendor to receive 100% of said base invoice amount. The investor is compensated with the difference between interest on a loan to pay the vendor and later receipt of the penalty funds.

### CROSS-REFERENCE TO RELATED APPLICATIONS

This application claims priority to non-provisional application Ser. No. 13/224,274, filed on Sep. 1, 2011. The disclosure of the prior application is incorporated herein by reference.

### FIELD OF THE DISCLOSURE

The subject invention generally relates to a system and method for expediting payment to vendors for the goods or services performed by the vendors. More particularly, the invention relates to a computer implemented system and method for qualifying, tracking and paying a vendor 100% of an invoiced amount for the goods or services where a third party to the invoiced transaction pays the vendor and is compensated by a differential in interest rates between a preferred or prevailing market interest rate and a penalty interest rate owing to the vendor.

### BACKGROUND

Vendors generally supply goods and/or perform services for the buyers and expect to receive compensation from the buyers for those goods and/or services. Buyers receive the goods and/or services from the vendors and are expected to compensate the vendors for the goods or services received. The vendors typically supply an invoice to the buyers after the service is completed and/or the goods are delivered. The invoice generally describes the goods and/or services provided and the costs associated therewith.

Due, at least in part, to poor economic times many of the buyers are not able to pay the vendors in a timely manner. The vendors are forced to wait extended periods of time to be paid for the goods and/or services they provided for the buyers. Having to wait the extended periods of time creates financial hardship on the vendors and the vendors' companies. The vendors may be forced to layoff workers. Additionally, the vendors may not be able to purchase materials to complete future jobs if they are not timely paid for the work they have completed.

Factoring plans are widely known as an alternative method of getting the vendors paid more quickly. Under a typical factoring plan, the vendor sells the right to collect payment under the invoice to a third party. However, under these plans, the third party purchases the rights at a deeply discounted rate. Although the vendor may be able to receive payment for the goods and/or services more quickly, the vendor is only able to collect a fraction of the invoiced amount.

Therefore, there remains a need for an improved system for expediting payment to the vendors and ensuring that the vendors receive most, if not all, of the invoiced amount for the goods and/or services provided.

### SUMMARY

The present disclosure provides for a service system for facilitating payment to a vendor supplying products to a buyer. The payment is disbursed by an investor on behalf of the buyer over a computer network. When the vendor supplies the products to the buyer, the vendor submits an invoice for the products to the buyer. The invoice includes a base invoice amount and may be submitted to the buyer via the computer network. If the invoice is not paid in a timely manner, an amount of penalty funds are calculated from the base invoice amount. The service system provides for an application to be submitted to an investor over the computer network for enrolling into the service system based on the unpaid invoice. The service system includes a vendor computer system in communication with the computer network for transmitting the application and the invoice to the investor. The service system further includes an investor computer system in communication with the vendor computer systems via the computer network for receiving the application and the invoice from the vendor computer system. At least one installment is disbursed from the buyer and received by the investor via the computer network. At least one payment disbursed from the investor and received by the vendor via the computer. The at least one payment is equal to the base invoice amount thereby allowing the vendor to receive 100% of the base invoice amount. The present disclosure also provides a method of facilitating payment to a vendor supplying products to a buyer.

### DESCRIPTION OF THE DRAWINGS

The present invention will become more fully understood from the detailed description and the accompanying drawings, wherein:

Other advantages of the present invention will be readily appreciated, as the same becomes better understood by reference to the following detailed description when considered in connection with the accompanying drawings wherein:

FIG. 1 is a block diagram illustrating interactions between a buyer and a plurality of vendors;

FIG. 2 is a block diagram illustrating the system of the present disclosure;

FIG. 3 is a timeline illustrating a comparison of the timing for the vendor to receive compensation for goods and/or services;

FIGS. 4 through 9 are block diagrammatic flows of an embodiment of the method and system for a vendor assistance program;

FIGS. 10 through 21 are illustrative “screen shots” of components of the disclosed system; and

FIGS. 22 and 23 are block diagrams illustrating an embodiment of the system of the disclosure.

### DETAILED DESCRIPTION

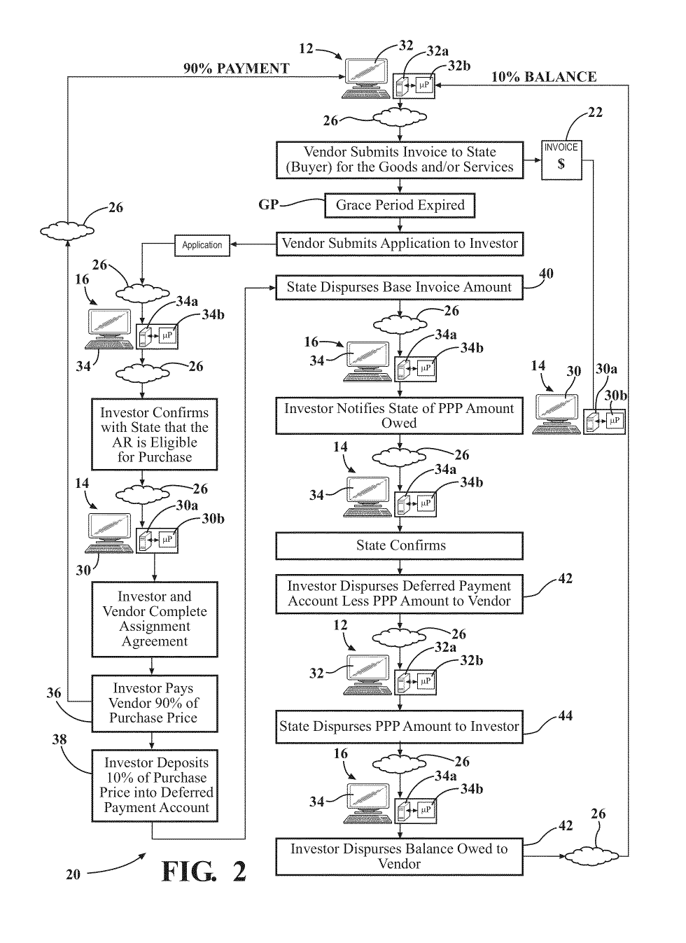

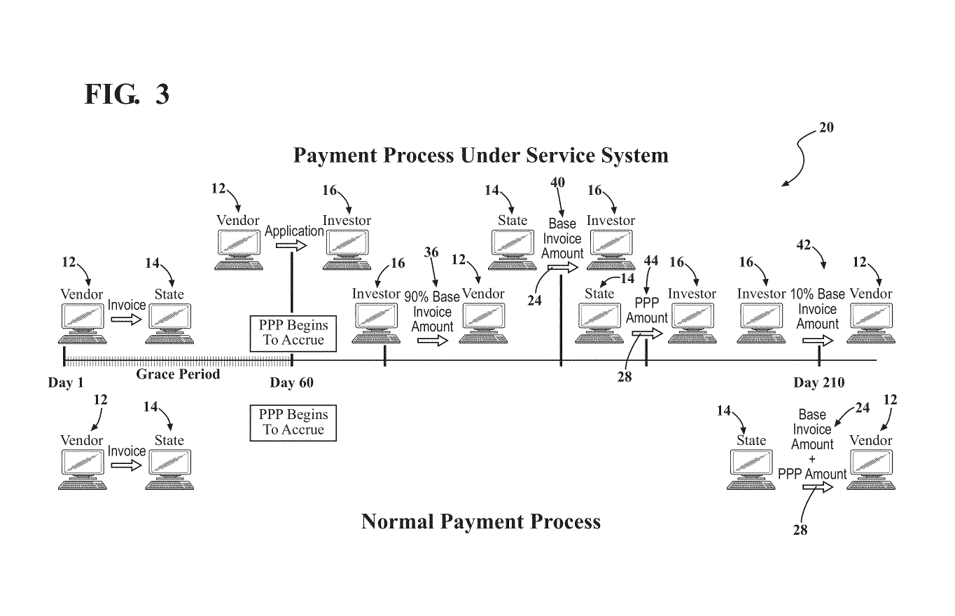

With reference to the FIGS. 2 and 3, a service system for expediting payment to at least one vendor 12 is generally shown at 10. The system 10 typically comprises the vendor 12, at least one buyer 14, and at least one investor 16. It is to be appreciated that any number of parties from the above listed categories may be involved in the system 10 of the present disclosure. In other words, the system 10 may include a plurality of vendors, a plurality of buyers, and/or a plurality of investors.

The buyer 14 may be a state 14, county, city, town, or other municipality. Additionally, the buyer 14 may be another type of entity or individual that receives goods and/or services from the vendor 12. Many buyers 14, particularly states 14, are facing a cash-flow deficit and are forced to delay payments to the vendor 12 providing goods and/or services for extended time periods, e.g. in excess of 200 days or more. Many of the vendors 12 working with the states 14 may include non-profit organizations, school districts, public universities, prison systems, pension plans, small private contractors and other similar entities. These vendors 12 are facing significant financial hardships because they rely on the state 14 for their business and are forced to wait the extended time periods to be paid for the goods and/or services supplied to the state 14.

Rather than waiting the extended time periods, the vendor 12 may choose to sell the rights to the payments from the state 14 to third parties at deeply discounted rates, such that the vendor 12 may only receive a fraction of the amount owed by the buyer 14, typically about 60% to 70% or less. This discounted selling of rights to collect payment owed is generally known in the art as factoring. The system 10 of the present disclosure is not a factoring program because the vendor 12 is able collect the full amount owed to the vendor 12 for the goods and/or services.

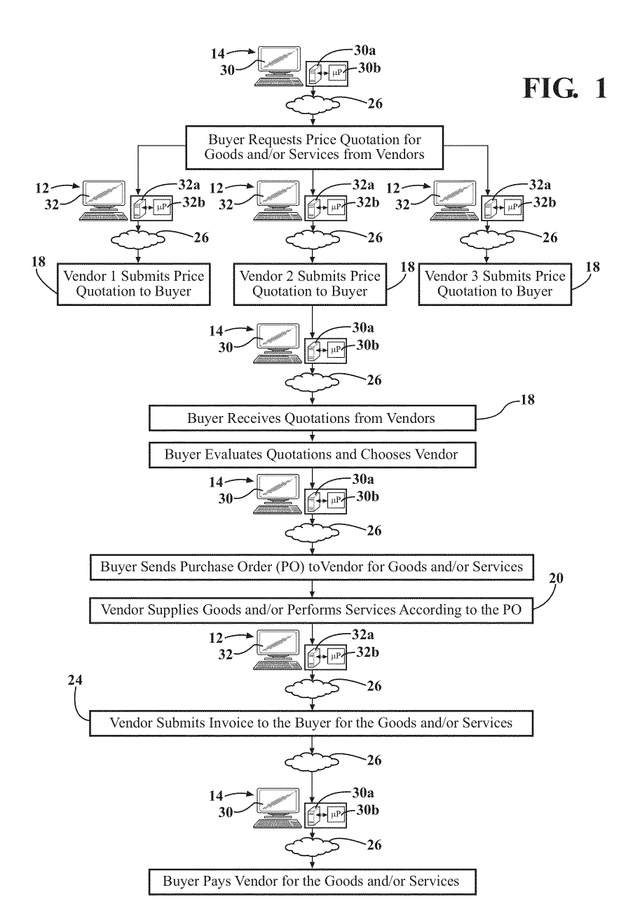

With reference to FIG. 1, a typical buyer-vendor transactional relationship is illustrated. The buyer 14 requests a price quotation 18 for goods and/or services from at least one vendor 12, more typically from a plurality of vendors 12. Each vendor 12 submits a price quotation 18 to the buyer 14. The buyer 14 will then choose one of the vendors 12 and send a purchase order (PO) 20 to the vendor 12 chosen. The vendor 12 chosen supplies the goods and/or services to the buyer 14 according the PO 20 and sends an invoice 22, comprising a base invoice amount 24, to the buyer 14 for the goods and/or services supplied. After the buyer 14 confirms and verifies that goods and/or services conform to the PO 20, the buyer 14 will distribute a payment to the vendor 12. Typically, these interactions between the buyer 14 and the vendor(s) 12 are typically conducted over a network 26, preferably a computer network 26 such as the Internet, i.e., the World Wide Web. However, there is typically a grace period GP between the time the vendor 12 supplies the goods and/or services and when the vendor 12 gets receives compensation for the goods and/or services. Generally, the grace period GP is from about 30 to 60 days. It is to be appreciated that the grace period GP is not particularly limited and may be less than 30 days or the grace period GP may be longer than 60 days.

Returning to FIGS. 2 and 3, many states 14 have enacted Prompt Payment legislation to impose penalties upon themselves for not paying the vendor 12 in a timely manner. In other words, the vendors 12 are able to collect additional funds (penalty funds) 28 from the state 14 if the invoice 22 submitted to the state 14 is not paid in a timely manner, i.e., within the specified grace period GP. These penalty funds 28 are further defined as prompt payment penalties (PPP) 28. The PPP 28 is typically calculated as a percentage of the base invoice amount 24 of the invoice 22 after the grace period GP. The base invoice amount 24 is further defined as the financial amount of the invoice 22 supplied to the state/buyer 14 by the vendor 12. Although the specific details of the legislation may vary between the states 14, the legislation typically identifies the length of the grace period GP and a method of calculating PPP 28 if the vendor 12 is not paid within the grace period GP identified. The percentage typically ranges from about 0.5% to 5% of the base invoice amount 24. More typically from about 0.75% to 3% of the base invoice amount 24. Most typically from about 1% to 2% of the base invoice amount 24.

The system 10 of the present disclosure is directed toward alleviating financial hardships placed on the vendor 12 by having to wait for payment from the state/buyer 14. Additionally, the system 10 provides for full payment of the base invoice amount 24 to the vendor 12, i.e., 100% of the invoiced amount. For illustrative purposes, an exemplary embodiment of the system 10 will be described below. For clarity, the illustrative embodiment will refer to each of the parties to the system 10 in the singular, e.g. the parties to the will be referred to as “the state 14,” “the vendor 12,” and “the investor 16.” However, it is to be appreciated that the system 10 may include a plurality of any or all of these parties. Additionally, it is to be appreciated that the system 10 is typically conducted over the network 26, preferably the Internet.

The state 14 has a buyer computer system 30 comprising a buyer database 30a and a buyer processor 30b. The buyer computer system 30 is in communication with the computer network 26. Each vendor 12 has a vendor computer system 32 comprising a vendor database 32a and a vendor processor 32b. The vendor computer system 32 is also in communication with the computer network 26. Additionally, each investor 16 has an investor computer system 34 comprising an investor database 34a and an investor processor 34b. The investor computer system 34 is in communication with the computer network 26. Further, the buyer computer system 30, the vendor computer system 32, and the investor computer system 34 are in communication with one another via the computer network 26.

Before the investor 16 is able to participate in the system 10, the investor 16 must be approved by the state 14. Typically to be approved by the state 14, the investor 16 must demonstrate the ability to invest or obtain investment funds that meet minimum purchase commitments and creditworthiness requirements. The investor 16 will typically commit to a minimum purchase amount and to be bound to that amount as a condition of participation in the system 10. The investor 16 may be an individual or an entity. It is to be appreciated that each state 14 may include additional requirements for approving the investor 16 for participation in the system 10.

Each invoice 22 submitted to the state 14 is further defined as an account receivable (AR) 22 for the vendor 12. The AR 22 typically must meet certain criteria to be available for purchase by the investor 16 under the system 10. The AR 22 may be the entire base invoice amount 24 or any unpaid portion of the base invoice amount 24. To be available for purchase under the system 10 of the present disclosure, the AR 22 must be outstanding beyond the grace period GP. In other words, the AR 22 has not been paid by the state 14 in a timely manner and the grace period GP has expired. The AR 22 must also be eligible to receive PPP 28 and is not prohibited or otherwise prevented from being transferred or assigned to a third party, e.g. the investor 16. Additionally, accuracy of the amount of the AR 22 must typically be verified by the state 14, specifically by an agency within the state 14 receiving the goods and/or services. The AR 22 may be subject to state offsets, meaning that the state 14 may deduct money owed by the vendor 12 to the state 14, thereby lowering the monetary value of the AR 22. Again, it is to be appreciated that each state 14 may include additional requirements for approving the AR 22 for participation in the system 10.

Under the system 10, once the AR 22 becomes eligible for the system 10, as described above, the vendor 12 may submit an application to the investor 16. Preferably the application is submitted over the computer network 26. The application is transmitted by the vendor computer system 32 to the investor computer system 34 via the computer network 26. However, it is to be appreciated that the application may be submitted utilizing other methods, including, but not limited to, electronic mail (e-mail), postal mail, fax, hand delivery, etc. The vendor 12 is typically able to submit a plurality of application to a plurality of investors 16 at the same time. However, the vendor 12 is typically not permitted to submit multiple applications for the same AR 22 to multiple investors 16. The applications are typically prioritized chronologically, such that the earlier applications are processed through the system 10 first.

When the investor 16 receives the application, the investor 16 will confirm with the state 14 the AR 22 is qualified for purchase under the system 10. Specifically, the investor 16 will confirm whether there are any state offsets pending on the AR 22 for verifying how much the AR 22 is worth, thereby establishing a purchase price for the AR 22. Additionally, the investor 16 will also confirm that the grace period GP has expired and that the AR 22 is eligible to receive PPP 28. The investor 16 and the vendor 12 will then enter into an agreement to assign all the rights to receive payment under the AR 22 from the vendor 12 to the investor 16, including the base invoice amount 24 and the PPP 28 currently owed and that will accrue in the future. Whether the investor 16 may re-assign their rights to receive payment under the AR 22 is typically dependent upon the particular statute in the state 14.

The investor 16 then distributes an amount equal to the purchase price of the AR 22. Specifically, the investor 16 will distribute a first payment 36 from the investor computer system 34 to the vendor computer system 32 via the computer network 26. The first payment 36 is typically a majority of the purchase price of the AR 22, for example 90% of the purchase price. The investor 16 will deposit the remaining balance of the purchase price, e.g. 10% of the purchase price, into a deferred payment account 38. The deferred payment account 38 is typically maintained and controlled by the investor 16, such that there is no cost to the vendor 12. Specific guidelines for managing the deferred payment account 38 may be set forth by the state 14. The guidelines may vary from state to state.

The state 14 will then disburse an initial installment 40 in an amount equal to the base invoice amount 24 to the investor 16. Typically, the state 14 will transfer the initial installment 40 from the buyer computer system 30 to the investor 16 computer system via the computer network 26. Upon receipt, the investor 16 will typically send, via the computer network 26, an acknowledgement of receipt of the funds to the state 14 along with an estimate of PPP 28 owed by the state 14 based upon the number of months beyond the grace period GP. The state 14 will verify the actual amount of PPP 28 owed and send a notice to the investor 16 detailing the actual amount of PPP 28 the state 14 will pay and the date payment of PPP 28 will occur.

After the investor 16 receives the notice, the investor 16 may release funds from the deferred payment account 38. The investor 16 will retain an amount equal to the PPP 28 owed by the state 14 plus any amount of offset, if any, charged against the base invoice amount 24. The investor 16 will then disburse any remaining funds in the deferred payment account 38 from the investor computer system 34 to the vendor computer system 32 as a second payment 42 for the balance owed to the vendor 12. This second payment 42 may be a partial second payment.

The state 14 will disburse a final installment 44 in the amount of PPP 28 owed from the buyer computer system 30 to the investor computer system 34 via the computer network 26. When the investor 16 receives the final installment 44 of PPP 28 from the state 14, the investor 16 has been paid in full. The investor 16 will then disburse any remaining balance of the second payment 42 owed to the vendor 12 (if the second payment 42 described above was a partial second payment) from the investor computer system 34 to the vendor computer system 32, thereby making the vendor 12 whole. In other words, at this point, the vendor 12 has received 100% of the base invoice amount 24. It is to be appreciated that alternative methods of transferring funds may also be employed without deviating from the scope of the present disclosure.

The present disclosure also contemplates a method of facilitating payment to the vendor 12 of products which is disbursed by the investor 16 on behalf of the buyer 14. The method may include the step of providing the computer network 26. The method may also include the step of submitting the invoice 22 comprising the base invoice amount 24 to the buyer 14 via the computer network 26. The method may also include the step of calculating the amount of penalty funds 28 from the base invoice amount 24 when the invoice 22 is not paid in a timely manner. The method may also include the step of submitting the application to the investor 16 via the computer network 26 for enrolling the vendor 12 in the service system 10 based upon the invoice 22. The method may also include the step of providing the vendor computer system 32 in communication with the computer network 26 for transmitting the application and the invoice 22 to the investor 16. The method may also include the step of providing the investor computer system 34 in communication with the vendor computer system 32 via the computer network 26 for receiving the application and the invoice 22 from the vendor computer system 32. The method may also include the step of disbursing the first payment 36 from the investor 16 via the computer network 26 upon approval of the application. The method may also include the step of receiving the first payment 36 by the vendor 12 via the computer network 26. The method may also include the step of disbursing the initial installment 40 equal to the base invoice amount 24 from the buyer 14 via the computer network 26. The method may also include the step of receiving initial installment 40 by the investor 16 via the computer network 26. The method may also include the step of disbursing the final installment 44 equal to the amount of penalty funds 28 from the buyer 14 via the computer network 26. The method may also include the step of receiving the final installment 44 by the investor 16 via the computer network 26. The method may also include the step of disbursing the second payment 42 from the investor 16 via the computer network 26. The second payment 42 may be further defined as disbursing a plurality of partial second payments. The method may also include the step of receiving the second payment 42 by the vendor 12 via the computer network 26 wherein the first payment 36 and the second payment 42 are equal to the base invoice amount 24 thereby allowing the vendor 12 to receive 100% of the base invoice amount 24. The method may also include the step of retaining an amount equal to the amount of penalty funds 28 by the investor 16 as compensation.

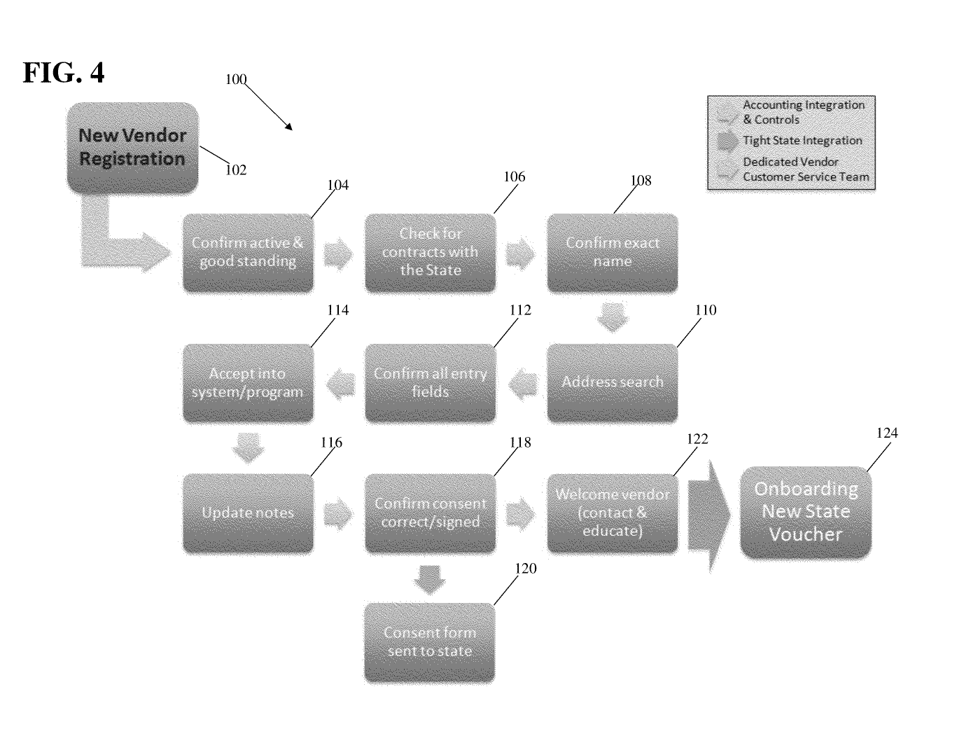

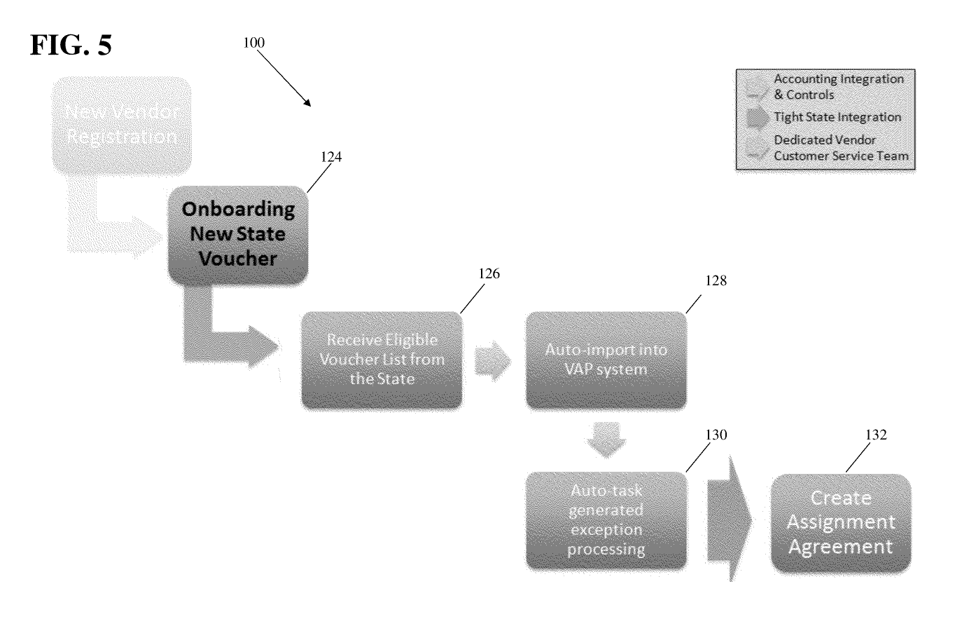

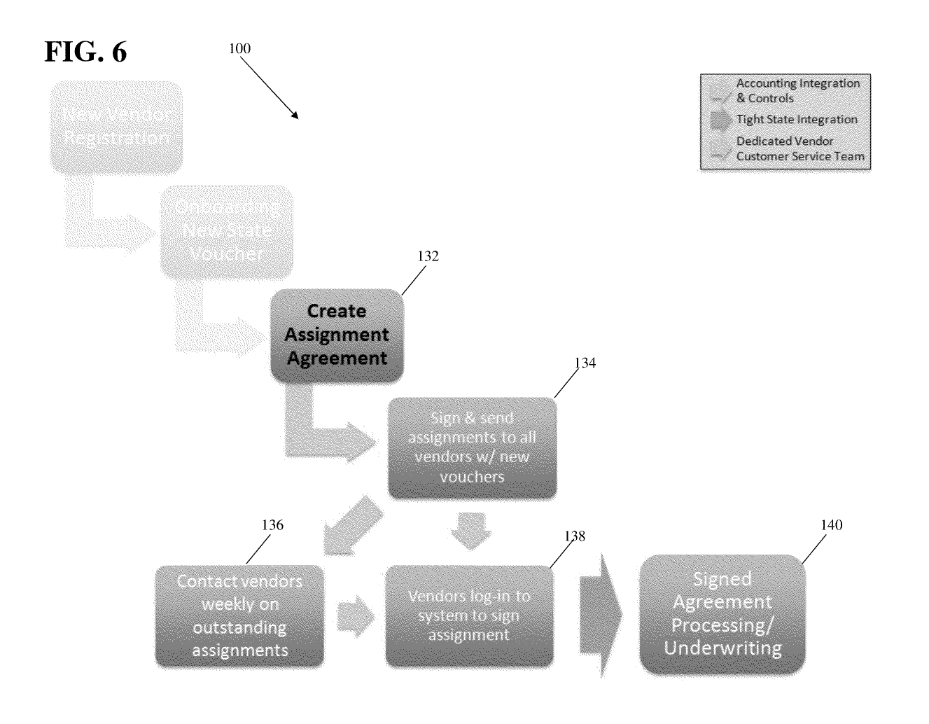

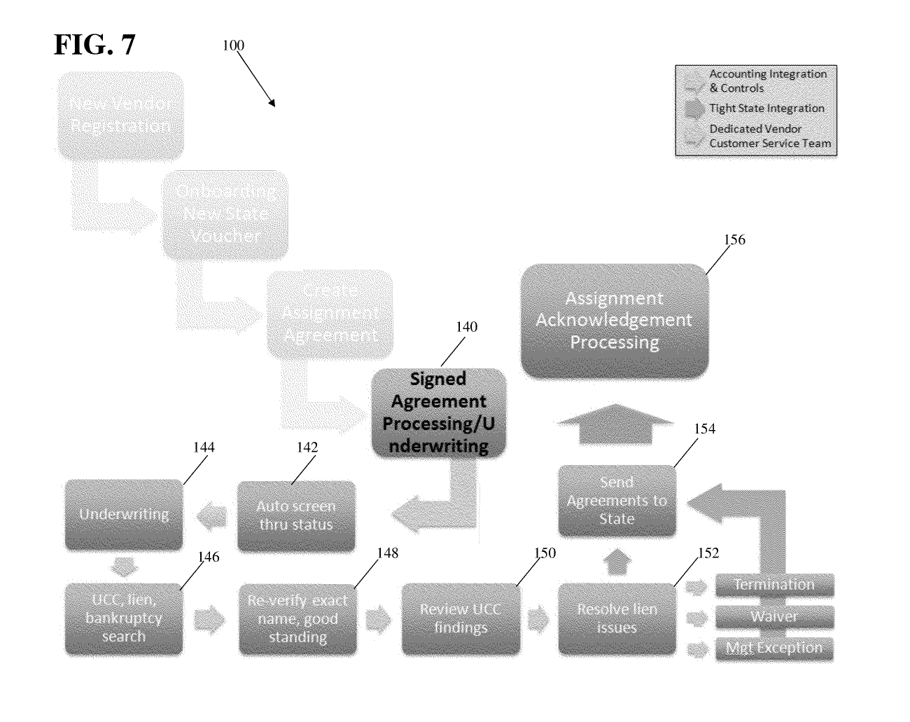

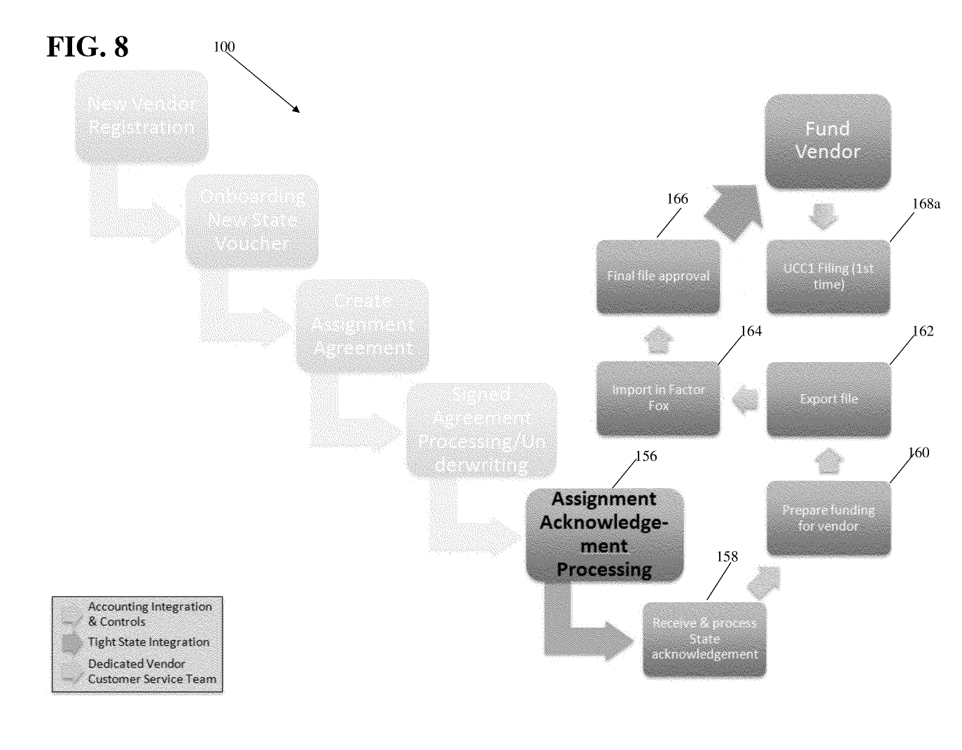

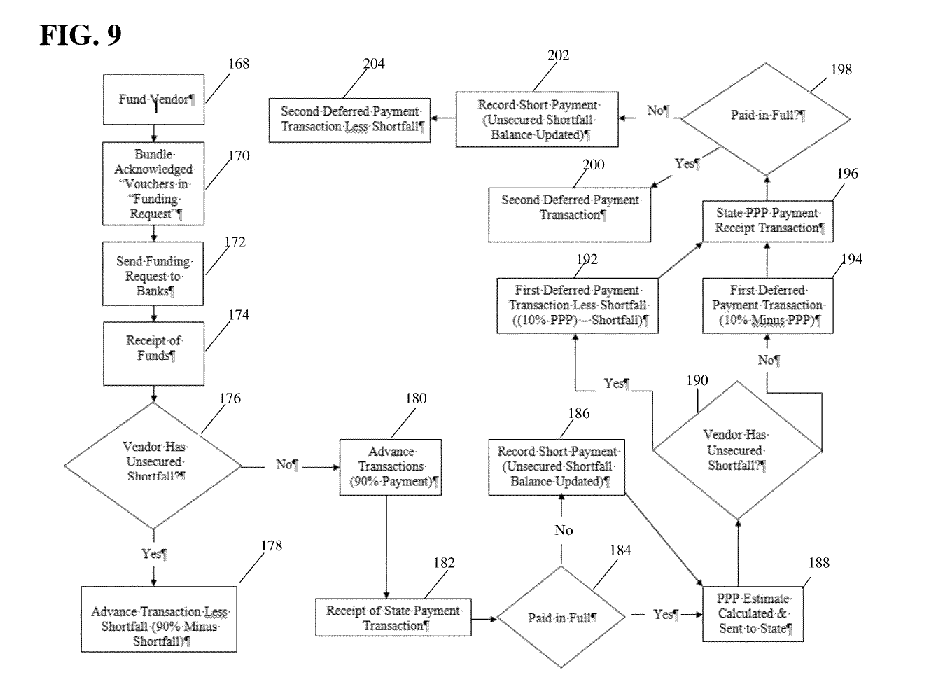

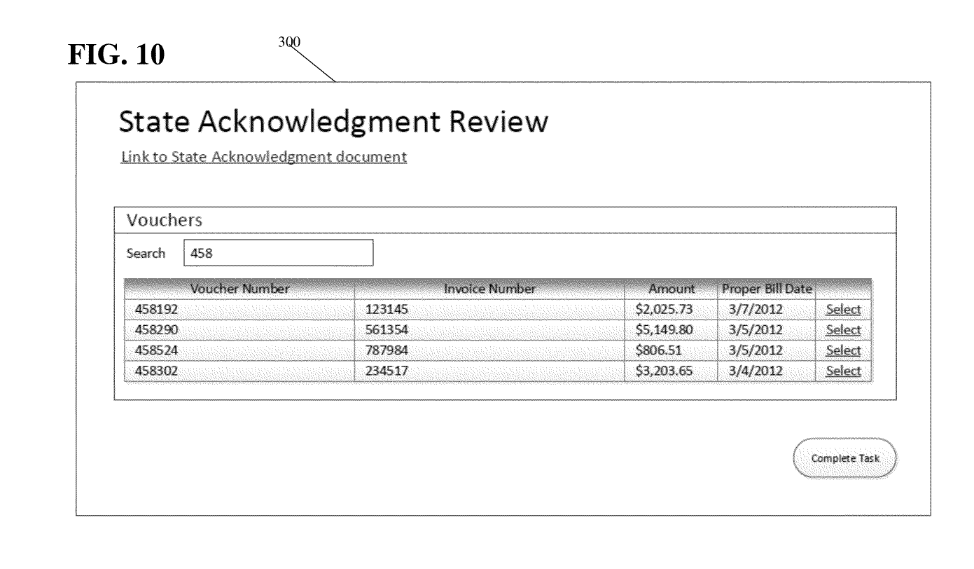

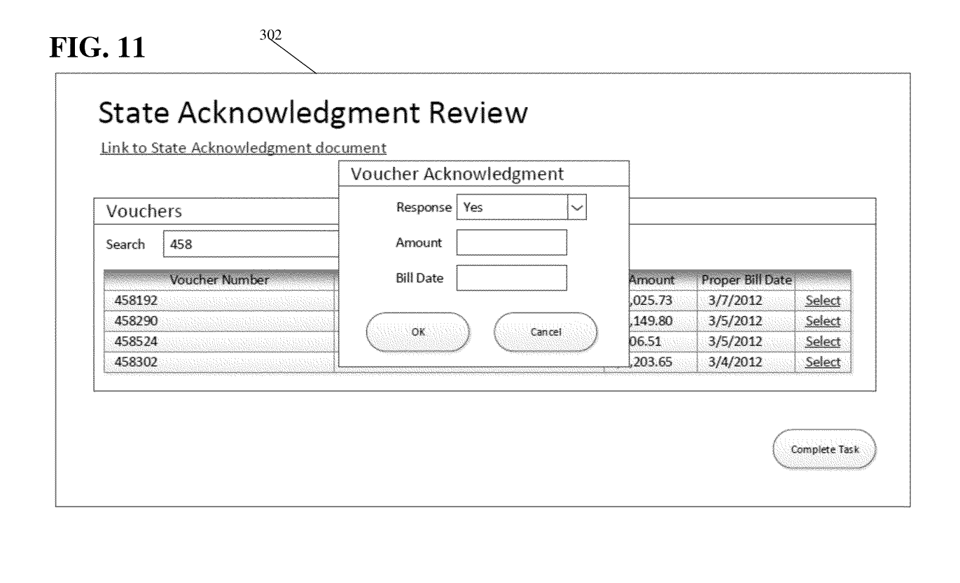

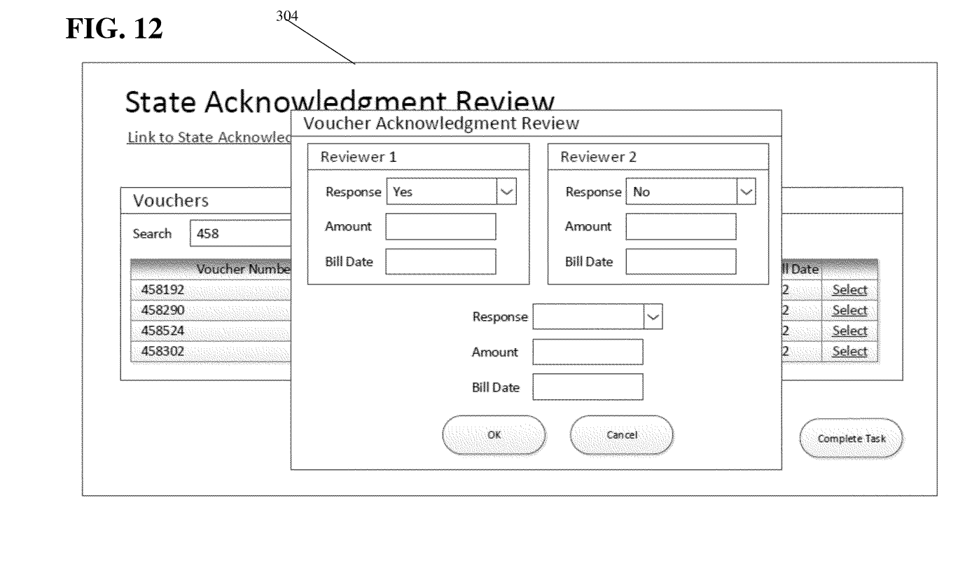

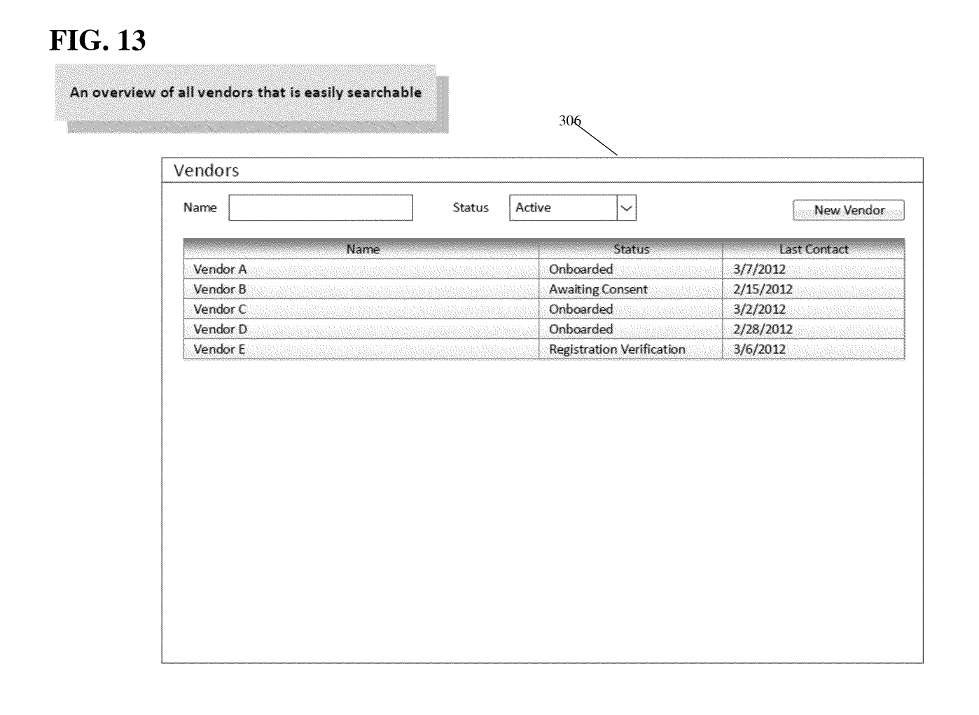

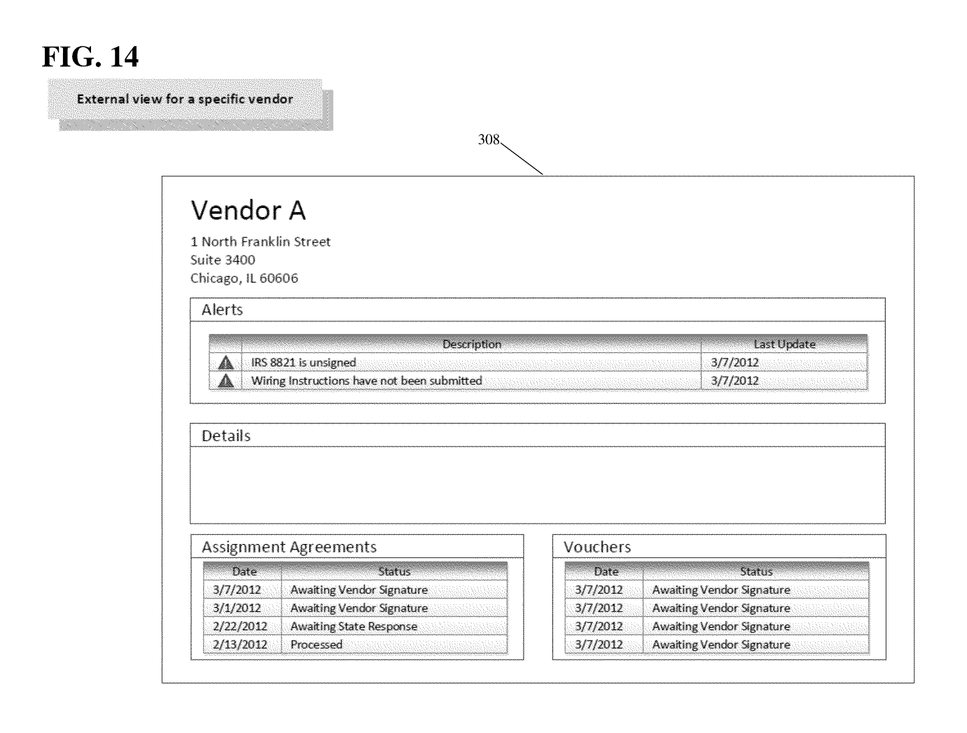

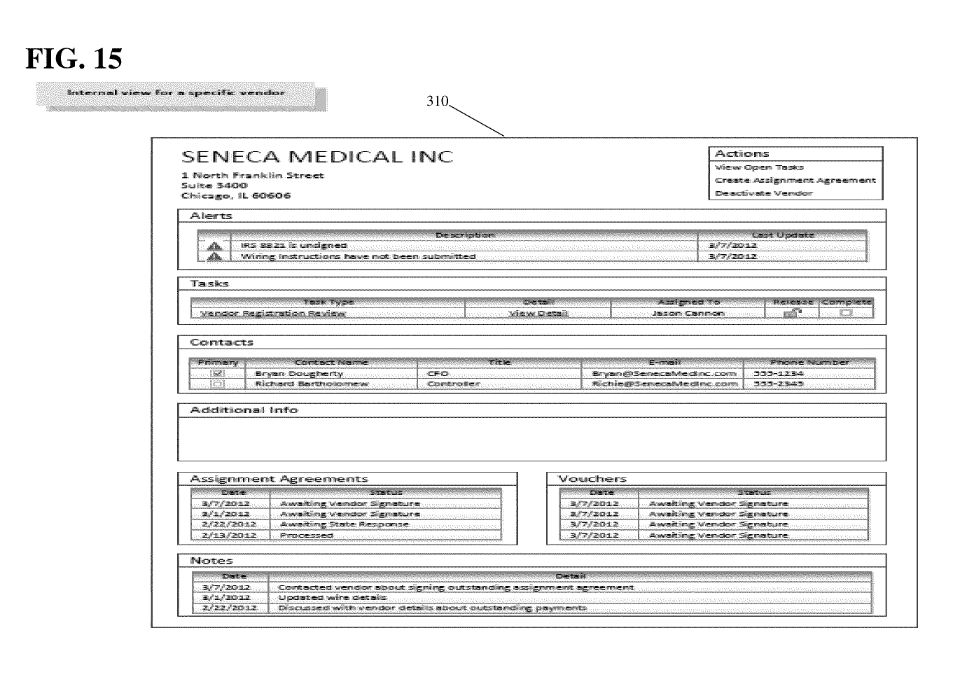

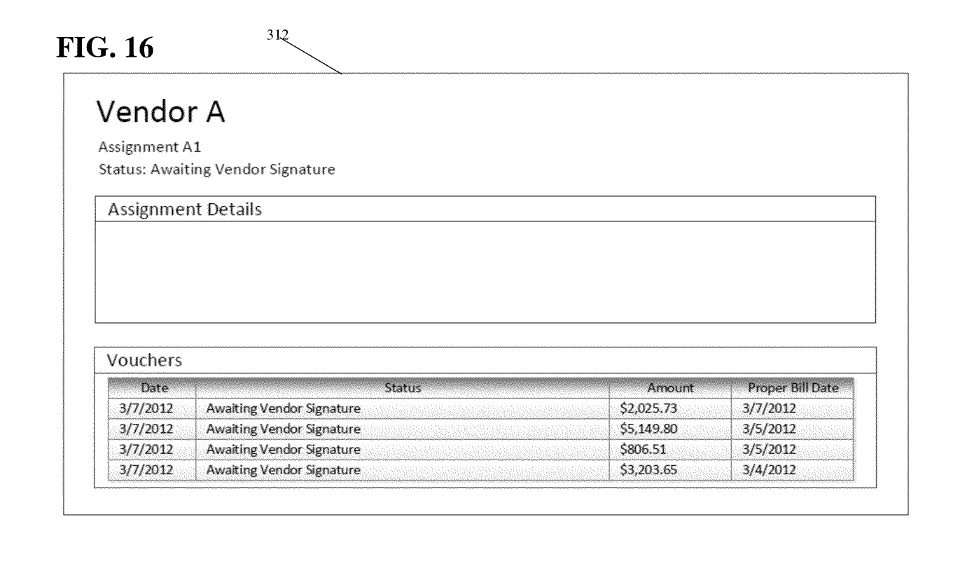

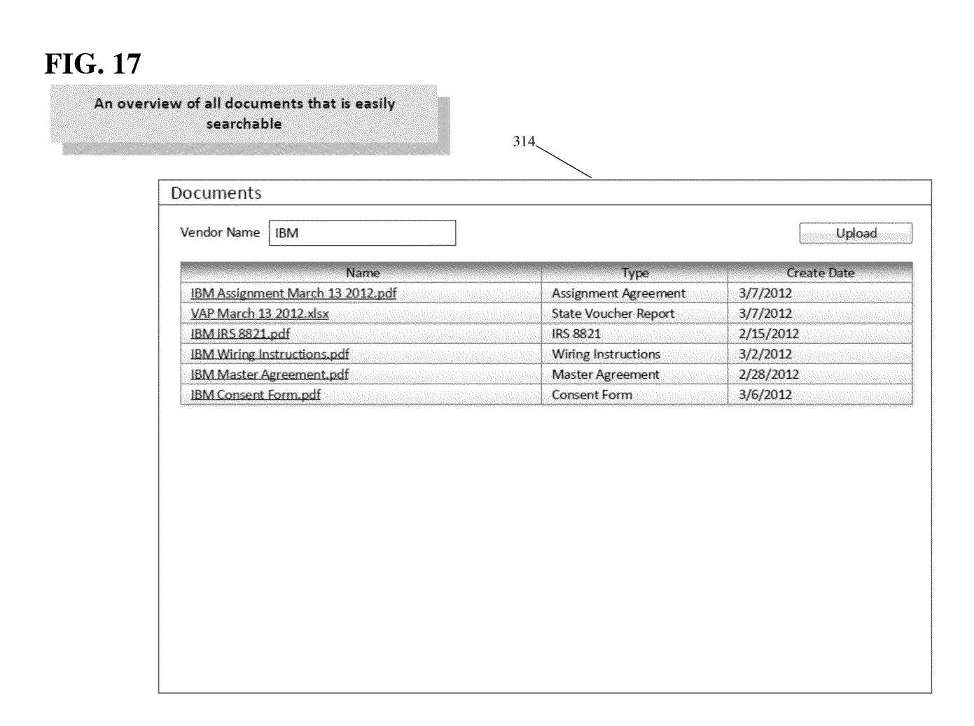

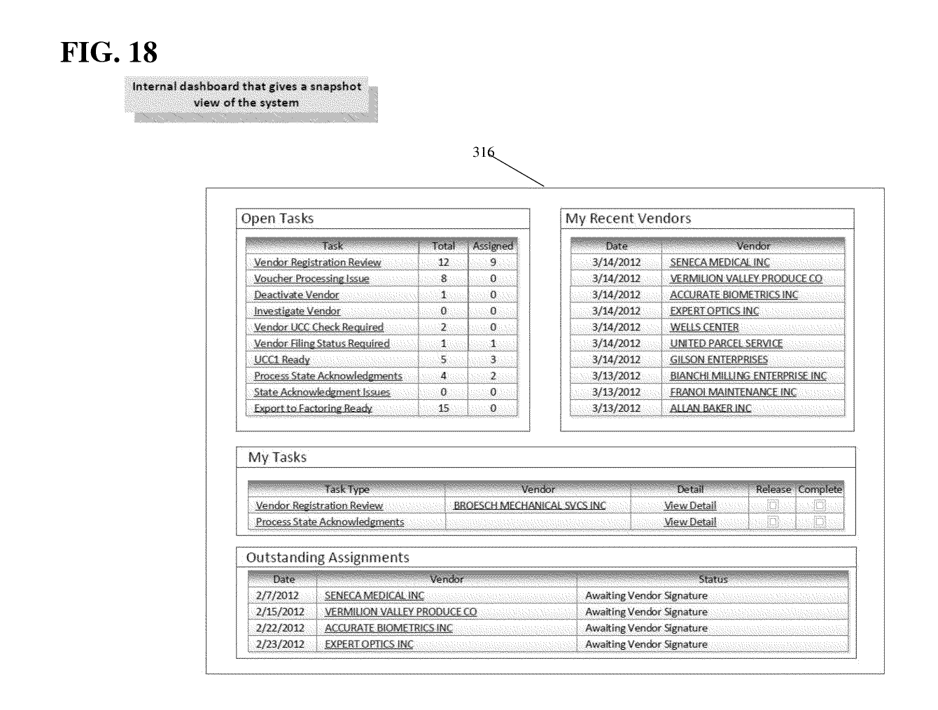

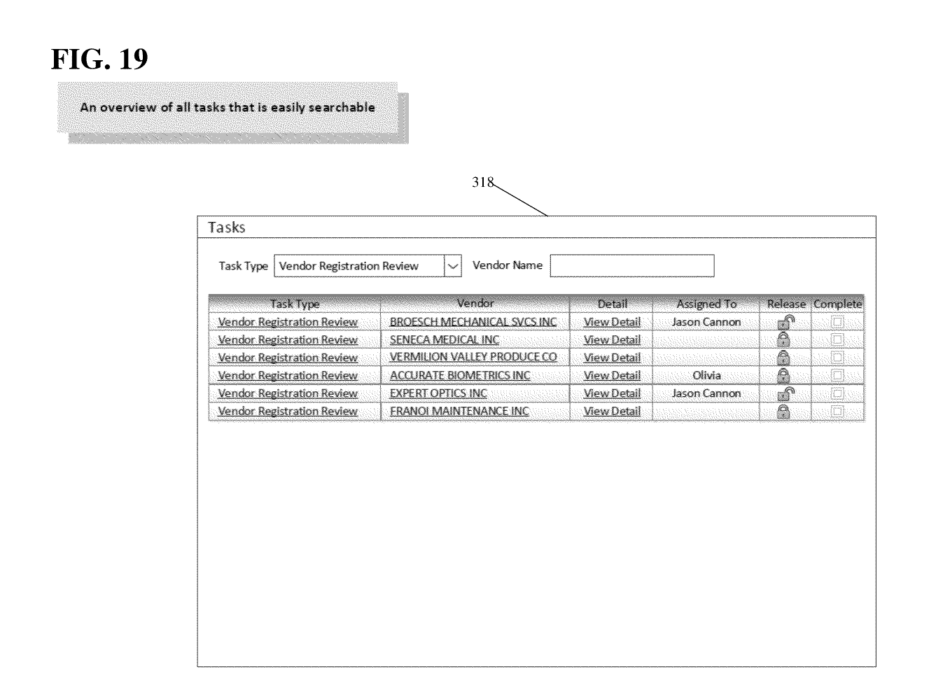

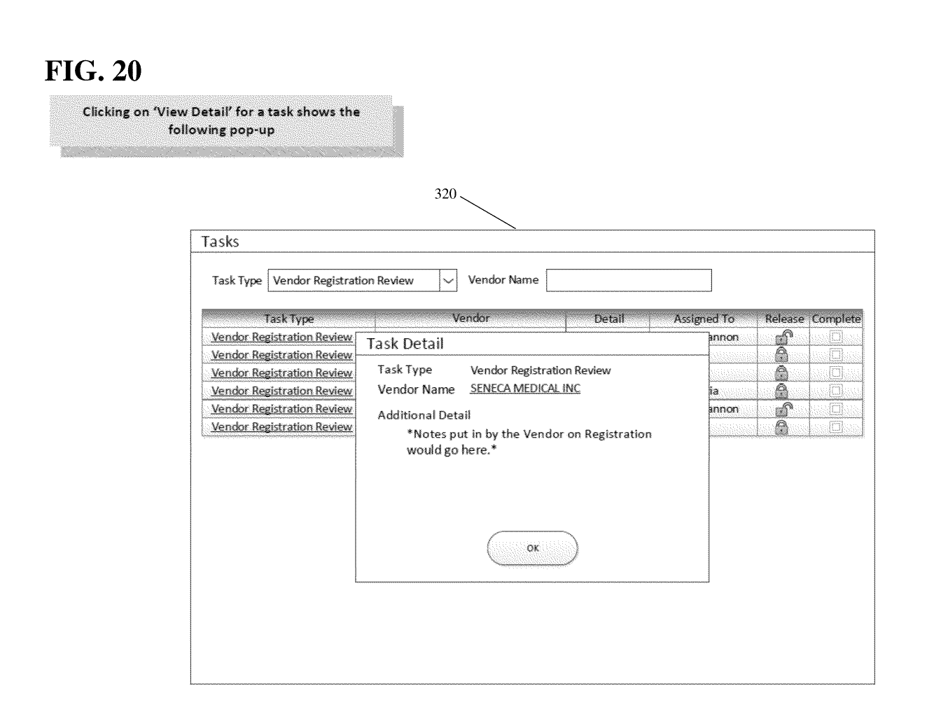

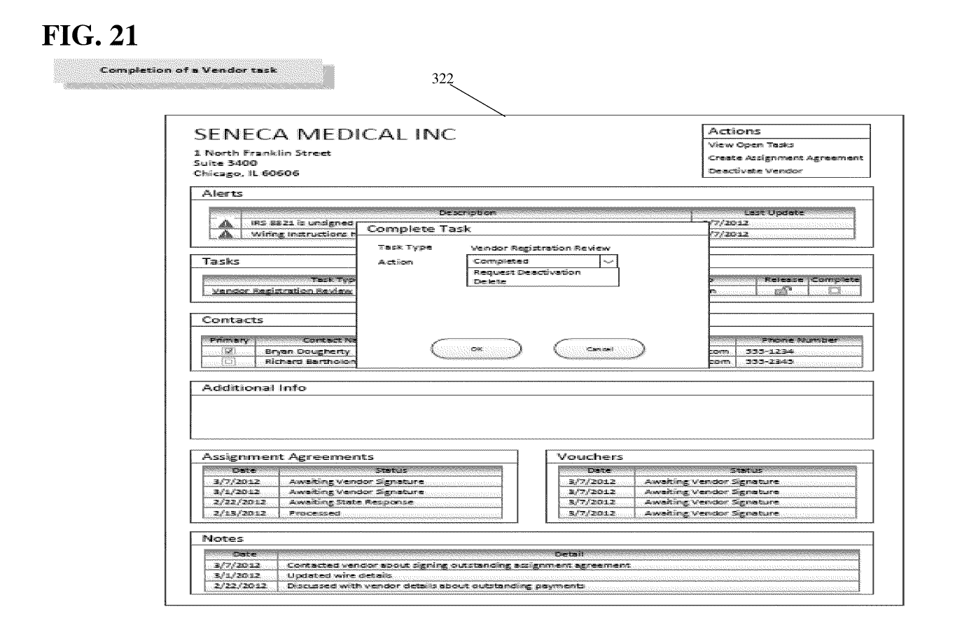

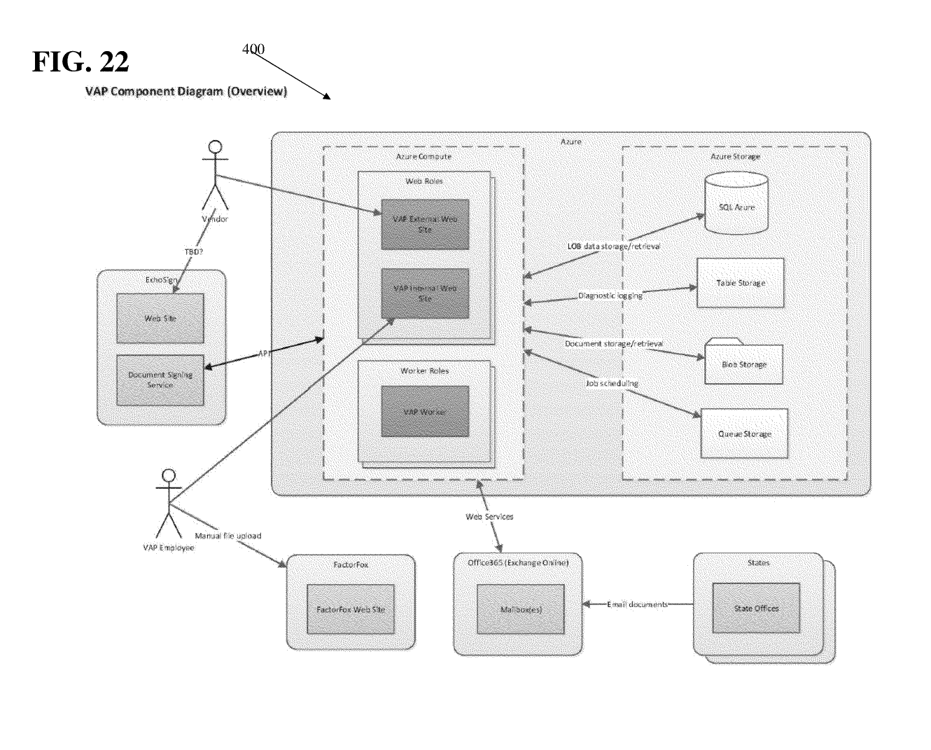

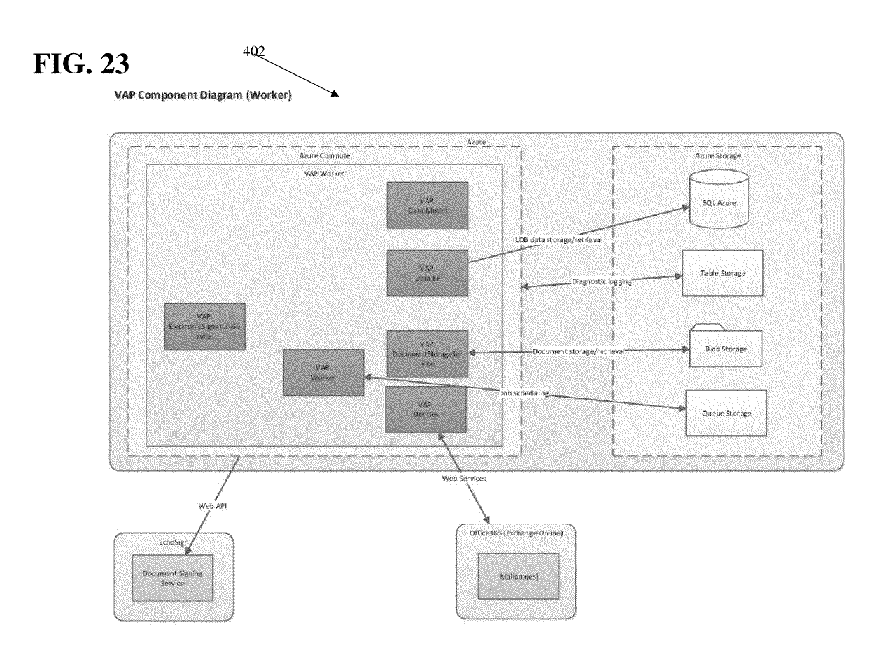

With further reference to FIGS. 4 through 23, in an embodiment, the system 10 and associated method 100 of the disclosure has steps including a new vendor registration 102. This includes steps 104, 106, 108, 110, 112, 114, and 116, starting with confirming that the vendor is active and in good standing; that it has existing contracts with the state; that its name is accurately represented in the system; that its address is correct; that information regarding the vendor is accurately confirmed in entry fields for registration with the vendor assistance program (VAP). At step 114, the vendor, thus qualified is accepted into the VAP program and in step 116, updated notes are made to confirm the registration. Next, in step 118, the vendor is requested to sign a consent for participation which is sent to the state in step 120 and then in step 122 the vendor is welcomed into the program and educated regarding the VAP services.

Turning now to step 124, new state vouchers for a registered vendor are accepted into the system 10. This includes at step 126 receiving an eligible voucher list from the state which may, for example, be an Excel spreadsheet parsible into discrete data segments corresponding to vouchers for registered vendors. Auto importing is performed at step 128 into the system 10 and in step 130, auto task exception processing allows for confirming and validating the correct relationship between a registered vendor and state submitted vouchers. Pending approval of these process steps, the next step 132 is to create an assignment agreement whereby the vendor 12 assigns to the investor 16 the vendor's account receivable owing from the state. In step 134, assignments are sent to vendors, along with the new vouchers and in step 136 the system reminder supports contacting a vendor weekly regarding outstanding assignments. As indicated in step 138, the vendor is permitted to log in to the system 10 to digitally sign the assignment. This may be accomplished through a document signing service such as Echosign or other suitable services.

As reflected in step 140 an underwriting activity is undertaken following receipt of the signed agreement. This includes in step 142 screening the status of the vendor and the assigned voucher and in step 144 underwriting including in step 146 investigating for liens or bankruptcy of the vendor or other encumbrances to the vendor's ability to make an assignment of its rights to money owing through the state invoice. This also includes in step 148 confirming the good standing of the vendor and in step 150 reviewing any UCC filings, along with in step 152 resolving any lien issues that may result in a termination of the agreement pending satisfactory completion of these steps.

Next, in step 154, the vendor assignment agreements are sent to the state and in step 156 assignment acknowledgement processing is undertaken. This includes receiving and processing a state acknowledgement as indicated in step 158 and then preparing funding for the vendor in step 160. Next, the file is exported in step 162 and in step 164 imported into Factor Fox a data processing application, resulting in final approval in step 166 and funding of the vendor in step 168. A UCC-1 filing is next performed in step 168a. Next, in step 170, acknowledged vouchers are bundled in a “funding request” and in step 172 the funding request is sent to a lending institution such as a bank. In step 174, funds are received as a loan from the bank on an interest rate negotiated between the bank and VAP program and/or the investors. Preferred or prevailing market interest rates are typically available.

Next, in step 176, if the vendor has an unsecured shortfall, then the vendor receives an advance payment less the shortfall (90% minus the shortfall). If the vendor does not have a shortfall, then in step 180 the vendor receives a 90% payment of the covered invoice amount. In step 182, receipt is made of a state payment transaction and in step 184 it is evaluated for payment in full status. If no payment in full, then in step 186 it is recorded in the system as a short payment and results in an unsecured shortfall balance. If paid in full, then in step 188 the PPP estimate is calculated and sent to the state. In step 190, if the vendor has an unsecured shortfall, then in step 192 a first deferred payment transaction less the shortfall is made (again, 10% minus PPP minus shortfall). If the vendor does not have an unsecured shortfall, then in step 194, a first deferred payment transaction is made (10% minus PPP). Then in step 196, the PPP payment is received from the state and consideration is given in step 198 whether payment has been made in full. If yes, then a second deferred payment transaction is recorded in step 200 and if not, then in step 202 the short payment is recorded, acknowledging an unsecured shortfall balance update. Next, in step 204, a second deferred payment is made less the shortfall. During or at the end of these steps the loan from the bank is repaid including interest owing on the loan. The investor is compensated by receiving the PPP which is typically paid at a higher interest rate than the interest rate on the loan from the bank. Following a completed cycle of the method, the difference between the PPP (together with the invoice amount) and any interest owed to the bank (together with the loan amount) goes to the VAP.

The steps of the method and this system provide a state acknowledgement review 300 including a display and review of vouchers, invoice number amount and bill date. This includes a voucher acknowledgement 302 and a voucher acknowledgement review 304.

The system 10 further provides for a display and overview of all vendors that is easily searchable 306 including detail about specific vendors 308 providing detail regarding assignment agreements, vouchers, alerts and other details. The system also provides an internal review 310 providing additional detail regarding the vendor's status. In addition, the system includes a vendor status 312 indicating vendors awaiting signature. The system further provides a module 314 for providing an overview of all documents including searchability of the documents described as necessary to the method and system described herein. An internal dashboard 316 provides a snapshot view of the system, including open task vendor details, tasks to be completed in the method and outstanding assignments. This includes a task module 318 for display of all tasks, including a searching function. The task module 318 also includes a pop-up window 320 showing detail regarding the task. A task completion module 322 indicates completion of the task.

The system 10 is computer implemented in the sense that it relies upon computer hardware systems and software applications integrated in a system platform 400, 402 including interaction of internal and external web-based applications, communicating with database systems, and application programs interfacing with external applications or using web-based services for communication and interaction with services such as Microsoft Exchange or Factor Fox. In practice, this system is network reliant and including cloud-based distribution of processing and data storage although those skilled in the art would be able to implement this system in other variations. However, it is clear that this system must be computer implemented, at least in part, in order to fulfill approving vendors, tracking the steps of the processes, and making sure that proper payments are being made and receipts are received in order to adequately arbitrage and profit by taking on the risk of a loan from the bank in order to pay a vendor in advance while seeking profit from the difference in the interest paid for the loan and penalty interest owing from a state to the vendor.

The present invention has been described herein in an illustrative manner, and it is to be understood that the terminology which has been used is intended to be in the nature of words of description rather than of limitation. Obviously, many modifications and variations of the invention are possible in light of the above teachings.

What is claimed is:

1. A vendor assistance system for facilitating payment to a vendor for products or services purchased by a governmental entity wherein the governmental entity owes a penalty interest if late payment is made to the vendor wherein a third party pays the vendor the invoiced amount owing to the vendor in exchange for receiving the penalty interest from the governmental entity, said system comprising:
a computer network;
an invoice having a base invoice amount and submitted to the governmental entity via said computer network;
a software application operated by the third party and in communication with the governmental entity through the computer network wherein the software application has a new vendor registration module, a new state voucher module, a create an assignment agreement module, a signed agreement processing module, a vendor payment module and a governmental entity receivables module for tracking payments owed by the governmental entity including interest penalty payments assigned by the vendor to the third party;
an amount of penalty funds calculated by the governmental entity receivables module from said base invoice amount when said invoice is not paid in a timely manner;
a loan amount obtained by the third party from a lender wherein at least a portion or the loan amount is paid to the vendor in exchange for the vendor's agreement to assign rights to penalty funds to the third party;
an application submitted to the third party via said software application for enrolling the vendor in the vendor assistance system based on said invoice;
wherein the software application identifies at least one installment disbursed from the governmental entity and received by the third party via said computer network;
wherein at least one payment is disbursed from the third party and received by the vendor thereby allowing the vendor to receive 100% of said base invoice amount; and
wherein the third party receives the penalty funds from the governmental entity.

2. A computer implemented method of a third party for facilitating payment to a vendor for goods or services purchased by a governmental entity, said method comprising the steps of:
providing by the third party a software application for registering vendors, onboarding state vouchers, creating assignments for the vendors, tracking payments to the vendors, and receipts from the governmental entity;
a vendor submitting an invoice having a base invoice amount to the governmental entity;
the software application operatively registering the vendor;
the software application operatively directing creation of an assignment agreement for the vendor to sign thereby assigning the vendor's rights to payment on the invoice to the third party;
the vendor assigning rights to the invoice amount to the third party;
the governmental entity agreeing to pay the invoice amount to the third party;
the third party taking a loan from a lending institution for at least a portion of the invoice amount;
the third party making a partial payment to the vendor of more than half of the invoice amount but less than the full invoice amount;
the third party tracking penalty interest owed by the governmental entity when the a delay in payment of the invoice amount results in the governmental entity owing penalty interest;
after the third party receiving full payment of the invoice amount from the governmental entity the third party paying the vendor any difference between the partial payment and the invoice amount thereby fully paying the invoice amount to the vendor; and
the third party receiving as compensation the difference the penalty interest and any accrued interest on the loan.
